(19) United States
(12) Patent Application Publication
(10) Pub. No.: US 2023/0189292 A1
(43) Pub. Date: Jun. 15, 2023

(54) TRIGGERING A REPORT OF A SET OF RESOURCES

(71) Applicant: Lenovo (Singapore) PTE. LTD., New Tech Park (SG)

(72) Inventors: Karthikeyan Ganesan, Kronberg im Taunus (DE); Prateek Basu Mallick, Dreieich (DE); Joachim Loehr, Wiesbaden (DE); Ravi Kuchibhotla, Chicago, IL (US)

(21) Appl. No.: 17/999,292

(22) PCT Filed: May 17, 2021
(86) PCT No.: PCT/IB2021/054228

§ 371 Date: Nov. 18, 2022

Related U.S. Application Data
(60) Provisional application No. 63/026,403, filed on May 18, 2020.
(60) Provisional application No. 63/026,425, filed on May 18, 2020.

(51) Int. Cl. H04W 72/25; H04W 72/02

(52) U.S. Cl. CPC H04W 72/25; H04W 72/02

(57) ABSTRACT

Apparatuses, methods, and systems are disclosed for triggering a report of a set of resources. One method includes receiving at a second user equipment, trigger information from a first user equipment. The trigger information indicates a request for a set of resource from the second user equipment. The method includes determining, by the second user equipment, the set of resources based on the trigger information from the first user equipment. The set of resources includes preferred resources, non-preferred resources, expected resources, potential resources, and/or detected resources. The method includes transmitting from the second user equipment, a report including the set of resource using a physical layer channel or a first medium access control control element. The first user equipment uses the set of resources to determine resource reselection.

### CROSS-REFERENCE TO RELATED APPLICATIONS

This application claims priority to U.S. Pat. Application Serial Number 63/026,425 entitled “APPARATUSES, METHODS, AND SYSTEMS FOR RECEIVER ASSISTANCE TO AVOID CONSECUTIVE ERRORS IN SIDELINK” and filed on May 18, 2020 for Karthikeyan Ganesan and U.S. Pat. Application Serial Number 63/026,403 entitled “APPARATUSES, METHODS, AND SYSTEMS FOR SL RESOURCE SELECTION ENHANCEMENT TO AVOID CONSECUTIVE PACKET LOSS” and filed on May 18, 2020 for Karthikeyan Ganesan, all of which are incorporated herein by reference in their entirety.

### FIELD

The subject matter disclosed herein relates generally to wireless communications and more particularly relates to triggering a report of a set of resources.

### BACKGROUND

In certain wireless communications networks, a set of resources may be used by a device. The set of resources may includes resources that conflict with resources of another device.

### BRIEF SUMMARY

Methods for triggering a report of a set of resources are disclosed. Apparatuses and systems also perform the functions of the methods. One embodiment of a method includes receiving, at a second user equipment, trigger information from a first user equipment. The trigger information indicates a request for a set of resource from the second user equipment. In some embodiments, the method includes determining, by the second user equipment, the set of resources based on the trigger information from the first user equipment. The set of resources includes preferred resources, non-preferred resources, expected resources, potential resources, and/or detected resources. In certain embodiments, the method includes transmitting, from the second user equipment, a report including the set of resource using a physical layer channel or a first medium access control control element. The first user equipment uses the set of resources to determine resource reselection.

One apparatus for triggering a report of a set of resources includes a second user equipment. In some embodiments, the apparatus includes a receiver that receives trigger information from a first user equipment. The trigger information indicates a request for a set of resource from the second user equipment. In various embodiments, the apparatus includes a processor that determines the set of resources based on the trigger information from the first user equipment. The set of resources includes preferred resources, non-preferred resources, expected resources, potential resources, detected resources, or some combination thereof. In certain embodiments, the apparatus includes a transmitter that transmits a report including the set of resource using a physical layer channel or a first medium access control control element. The first user equipment uses the set of resources to determine resource reselection.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for triggering a report of a set of resources;

FIG. 2 is a schematic block diagram illustrating one embodiment of an apparatus that may be used for triggering a report of a set of resources;

FIG. 3 is a schematic block diagram illustrating one embodiment of an apparatus that may be used for triggering a report of a set of resources;

FIG. 4 is a timing diagram illustrating one embodiment of a half-duplex transmission interference;

FIG. 5 is a schematic block diagram illustrating one embodiment of communications between user equipments;

FIG. 6 is a schematic block diagram illustrating another embodiment of communications between user equipments;

FIG. 7 is a schematic block diagram illustrating a further embodiment of communications between user equipments; and

FIG. 8 is a flow chart diagram illustrating one embodiment of a method for triggering a report of a set of resources.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

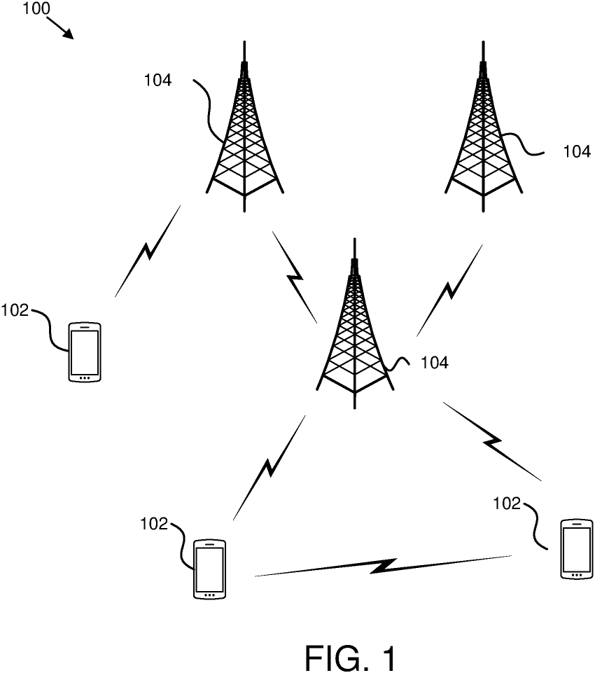

FIG. 1 depicts an embodiment of a wireless communication system 100 for triggering a report of a set of resources. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive, at a second user equipment, trigger information from a first user equipment. The trigger information indicates a request for a set of resource from the second user equipment. In some embodiments, the remote unit 102 may determine, by the second user equipment, the set of resources based on the trigger information from the first user equipment. The set of resources includes preferred resources, non-preferred resources, expected resources, potential resources, and/or detected resources. In certain embodiments, the remote unit 102 may transmit, from the second user equipment, a report including the set of resource using a physical layer channel or a first medium access control control element. The first user equipment uses the set of resources to determine resource reselection. Accordingly, the remote unit 102 may be used for triggering a report of a set of resources.

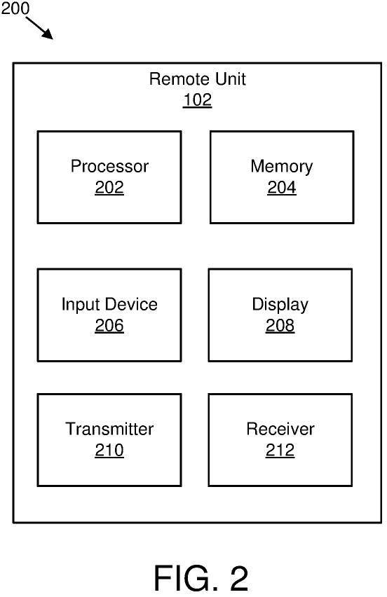

FIG. 2 depicts one embodiment of an apparatus 200 that may be used for triggering a report of a set of resources. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In some embodiments, the receiver 212 receives trigger information from a first user equipment. The trigger information indicates a request for a set of resource from the second user equipment. In various embodiments, the processor 202 determines the set of resources based on the trigger information from the first user equipment. The set of resources includes preferred resources, non-preferred resources, expected/potential and/or detected resource conflict on the resources, or some combination thereof. In certain embodiments, the transmitter 210 transmits a report including the set of resource using a physical layer channel or a first medium access control control element. The first user equipment uses the set of resources to determine resource reselection.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

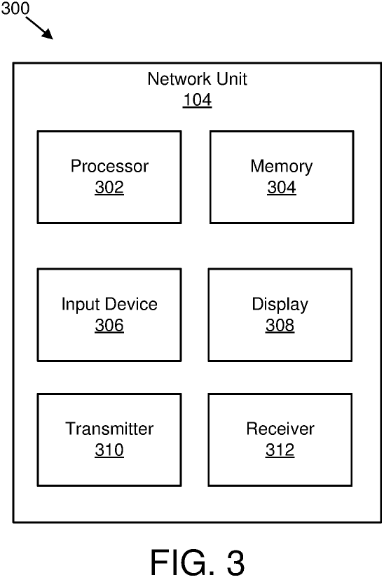

FIG. 3 depicts one embodiment of an apparatus 300 that may be used for triggering a report of a set of resources. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, sidelink resource selection enhancement for mode 2 may be made by analyzing various factors associated with consecutive packet loss. The factors associated with consecutive packet loss may include: 1) half duplex transmissions where a first user equipment (“UE”) (UEA) and a second UE (UEB) transmit in the same time slot and cannot hear each other’s transmissions; 2) consecutive negative acknowledgements (“NACKs”) and/or discontinuous transmission (“DTX”) reception from receiver (“RX”) UEs; 3) congestion in a resource pool; and/or 4) interference at a receiver side due to a hidden node.

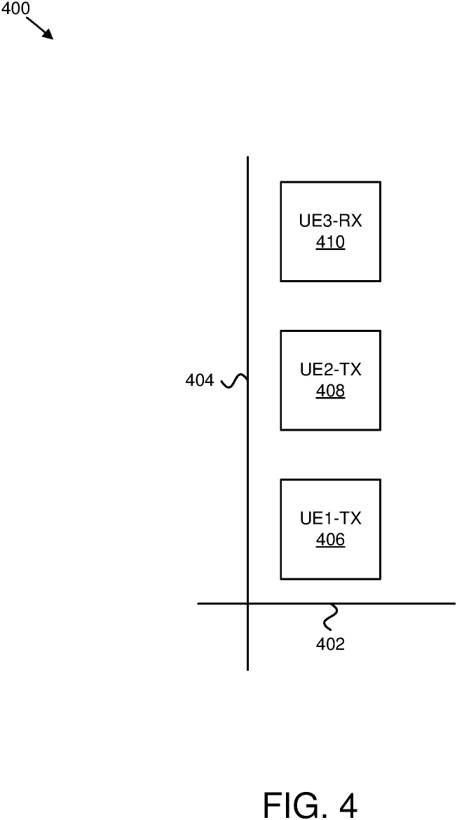

FIG. 4 is a timing diagram 400 illustrating one embodiment of a half-duplex transmission interference. The timing diagram 400 is illustrated over a time 402 and a frequency 404. Moreover, timing of communications between a first transmitter UE 406 (UE1-TX), a second transmitter UE 408 (UE2-TX), and a receiver UE 410 (UE3-RX) are illustrated. With transmissions from the first transmitter UE 406 to the receiver UE 410 being made at the same time as transmissions from the second transmitter UE 408 to the receiver UE 410, the receiver UE 410 receive both transmissions at the same time and they interfere with one another, but the first transmitter UE 406 and the second transmitter UE 408 may not be aware of the interference because they are half-duplex devices that cannot receive data at the same time they are transmitting data.

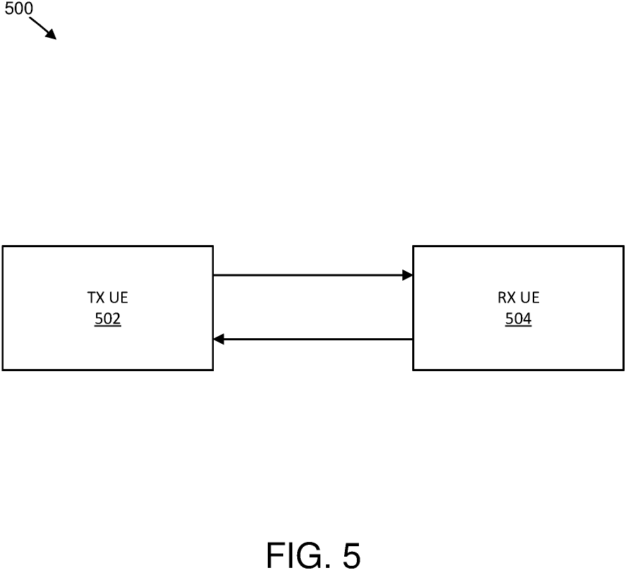

FIG. 5 is a schematic block diagram 500 illustrating one embodiment of communications between user equipments. The diagram 500 includes a transmitter (“TX”) UE 502 and an RX UE 504. The TX UE 502 may transmit information to the RX UE 504 indicating a source identifier (“ID”) of the TX UE 502 and a destination ID for one or more transmissions to be made by the TX UE 502 on one or more resources (e.g., destination ID configured from a higher layer in the TX UE 502). Moreover, the RX UE 504 may transmit information to the TX UE 502 indicating a source ID of the RX UE 504 and a destination ID for one or more transmissions to be made by the RX UE 504 on one or more resources (e.g., destination ID configured from a higher layer in the RX UE 504).

As used herein, embodiments may be described in relation to a destination ID. However, it should be noted that a TX UE may alternately use a source ID (e.g., layer 1 (“L1”) and/or layer 2 (“L2”)) of an RX UE, a destination ID, and/or a destination group ID (e.g., L1 and/or L2). As may be appreciated, the usage of a destination ID (e.g., L1 and/or L2) and a source ID (e.g., L1 and/or L2) may refer to the same RX UE.

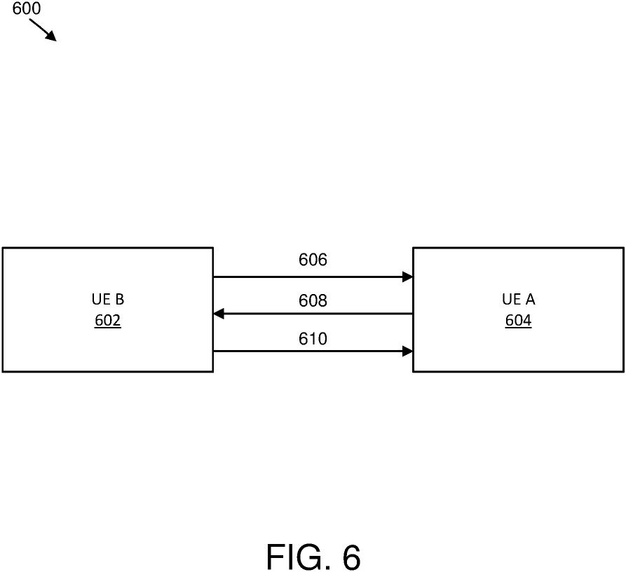

FIG. 6 is a schematic block diagram 600 illustrating another embodiment of communications between user equipments. The diagram 600 includes a first UE 602 (UE B) and a second UE 604 (UE A). The first UE 602 may transmit a trigger for inter-UE coordination message 606 to the second UE 604. Moreover, the second UE 604 may transmit an inter-UE coordination message 608 (e.g., a set of resource) to the first UE 602. Further, the first UE 602 may transmit a transmission 610 to the second UE 604.

In a first embodiment, there may be receiver assistance provided to avoid consecutive errors (e.g., handled like channel state information (“CSI”) reports). In such an embodiment, a trigger may be transmitted by a TX UE. Specifically, a TX UE may transmit a trigger either using sidelink control information (“SCI”), a medium access control (“MAC”) control element (“CE”), or UE to UE interface (“PC5”) radio resource control (“RRC”) to trigger reporting of a candidate resource set from a RX UE (e.g., Rx_CRS).

In one embodiment of the first embodiment, a MAC CE contains a bit or a bit field for triggering reporting of a candidate resource set (e.g., Rx_CSR - a preferred resource set generated from a UE’s sensing results) and may contain parameters such as a T2 minimum, a remaining packet delay budget (“PDB”) of a packet to be transmitted by a TX UE, a latency range of the Rx_CSR report transmission, a minimum communication range (“MCR”), a priority value to be used by RX UE for the transmission of Rx_CSR report, one or more resource pool indexes, a number of resources to be reported, and/or a percentage of total resources to be reported. A priority value of a MAC CE may be a value configured by a gNB, a preconfigured value, or a value indicated by the TX UE. Reference signal received power (“RSRP”) and/or received signal strength indicator (“RSSI”) thresholds for Rx_CSR, an interference report (e.g., an interference report may be a non-preferred resource set generated by a UE based on sensing results, an expected resource conflict, and/or a potential resource conflict), and/or a latency range for the transmission of a report may be configured by a gNB, preconfigured, or indicated by the TX UE.

In another embodiment of the first embodiment, PC5 RRC signaling may be used for triggering a Rx_CRS report and may contain parameters as described in other embodiments. In certain embodiments of the first embodiment, a TX UE may trigger a Rx_CRS report using a bit in 1st or 2nd stage SCI or using a separate 2nd SCI format and may contain parameters as described in other embodiments. In various embodiments of the first embodiment, a gNB may semi-statically configure one or more parameters per resource pool.

In certain embodiments, any combination of embodiments described herein may be used for signaling (e.g., depending on a cast type). In some embodiments, an RX UE may report Rx_CSR, an interference report, or both in response to being triggered by a TX UE. In various embodiments, a MAC CE priority may be configured differently than a channel quality indicator (“CQI”) and/or rank indicator MAC CE and a relative priority, and/or a relative remaining PDB and/or latency range may be compared to determine which one is transmitted if there are not enough resources granted.

In certain embodiments, an RX UE may prepare Rx_CSR. Specifically, a RX UE, after receiving a trigger from a TX UE either using SCI, a MAC CE, and/or PC5 RRC signaling, may perform a candidate resource selection process and a physical (“PHY”) layer may report the candidate resource set to a higher layer of the UE and/or may transmit a corresponding resource pool index, a sidelink (“SL”) subframe start and end of sensing, a usage of physical sidelink control channel (“PSCCH”) demodulation reference signal (“DMRS”) or physical sidelink shared channel (“PSSCH”) DMRS for sensing, a source ID, a destination ID, and/or a reporting type. In such embodiments, a threshold, in terms of a number of slots and/or slot offset may be configured (or preconfigured) by a gNB - the RX UE compares a slot at which a trigger is received with that of a slot in which a previous candidate resource set was triggered and is already available at the RX UE. If a time between the slots is equal or less than a threshold, then the RX UE does not trigger another candidate resource selection procedure and transmits Rx_CSR based on a previous candidate resource set already available.

In some embodiments, an Rx_CRS report contains a bitmap of a subchannel in a resource pool where candidate resources are not sorted according to highest RSSI and/or RSRP values. In such embodiments, a size of the bitmap depends on a number of subchannels in a resource pool. In various embodiments, a least significant bit (“LSB”) of a bitmap contains a lowest subchannel index, and a bit next to the least significant bit of the bitmap contains a next to lowest subchannel index, and so forth. For example, for a bitmap 01000111101, subchannel 0, 2, 3, 4, 5, and 9 are selected as candidate resources. In certain embodiments, a most significant bit (“MSB”) of a bitmap contains a lowest subchannel index, and a bit next to the most significant bit of the bitmap contains a next to lowest subchannel index, and so forth.

In various embodiments, a Rx_CRS report contains a bitmap of a subchannel in a resource pool sorted according to highest RSRP and/or RSSI values. For example, a sorted resource pool may include the following bitmaps: 0000000001, 0000000011, 00000010111, corresponding to subchannel 1, 3, and 23, where subchannel 1 contains the highest RSRP and/or RSSI, and so forth.

In certain embodiments, Rx_CSR may be reported by an RX UE. In some embodiments, a MAC CE may be used to report a Rx_CSR report, an interference report per resource pool, and/or other parameters described herein. In such embodiments, either different MAC CE fields are used to report the Rx_CSR or the interference report, or the same MAC CE field is used to report the Rx_CSR or the interference report with an indication indicating whether the MAC CE is for Rx_CSR or the interference report. The priority of the MAC CE and a latency range may be configured (or preconfigured) by a gNB or provided by a TX UE.

In some embodiments, in a mode 1 (e.g., gNB resource allocation), a MAC forms a transport block (“TB”) based on a MAC CE used to report a Rx_CSR report, an interference report per resource pool, and/or other parameters described herein. A scheduling resource (“SR”) may be configured for the MAC CE or Rx_CSR/interference report, and the SR may be triggered if a next available grant (e.g., configured grant (“CG”)) is far away from a configured latency bound and a corresponding timer may be started if a trigger for Rx_ CSR/interference report is received at a RX UE. The Rx _CSR MAC CE may be multiplexed with corresponding unicast data for a destination or Rx_CSR/interference MAC CE may be transmitted via groupcast and/or broadcast to an entire destination.

In various embodiments, in a mode 2 (e.g., UE autonomous resource allocation), a MAC forms a TB based on a MAC CE (e.g., used to report a Rx _CSR report, an interference report per resource pool, and/or other parameters described herein) to transmit in a first available resource or uses a randomly selected resource from Rx_CSR. In such embodiments, a T2 min, a T2 (e.g., PDB) may be configured according to a latency bound. In certain embodiments, PC5 RRC signaling may be used to transmit a Rx_CSR report or an interference report. In some embodiments, transmission of a report may be made using physical sidelink feedback channel (“PSFCH”) or may be piggy backed with PSSCH or SCI.

In certain embodiments, a TX UE may indicate transmission of a report using any PHY layer control signaling and a corresponding configuration format to be used, resource, beta-offset factor, and so forth. The transmission may be made in SCI, a MAC CE, PC5 RRC signaling, and/or semi-statically resources configured by a gNB per resource pool. A PSFCH resource for a format may occupy all or subset of sub-channels corresponding to a PSSCH transmission. If there are multiple PSFCH reports, then a resource for each of these reports may be based on a member ID.

In some embodiments, a MAC CE priority may be configured differently compared to CQI and/or rank indicator (“RI”) MAC CE and a relative priority, and/or a relative remaining PDB and/or latency bound compared to determine which one is transmitted if there are not enough resources granted.

In various embodiments, there may be specific TX UE behavior after reception a Rx_CRS report from an RX UE. In a first option, the TX UE reselects a resource from the received Rx_CRS/interference report based on whether the Rx_CRS report is received before or after m-T3. In second option, the TX UE may randomly select a resource from Rx_CRS or may select a resource based on highest RSSI and/or RSRP values.

In a third option, a TX UE triggers resource reselection and subsequently a MAC layer receives a candidate resource set (e.g., Tx_CRS). If the Tx_CRS is already available, then the MAC layer does not trigger resource reselection. The MAC select a resource that is present in both Tx_CRS and Rx_CRS and/or selects a resource based on highest RSRP and/or RSSI values from both Tx_CRS and Rx_CRS.

In a third option, instead of a candidate resource, a receiver UE may report an interference report (e.g., Rx_IR - may be a resource having RSSI and/or RSRP below a certain configured threshold) from all or a subset of sub channels and a TX UE may select a resource that is present in Tx_CRS, but not in the Rx_IR (e.g., removes resources from Tx_CRS set based on Rx_IR). The RX UE may report an interference report to the TX UE from its connection to multiple transmitters where the RX UE may use different beams, panels, and/or spatial filters for multiple transmitter UEs and the interference report may contain resources used by other TX UEs and their reserved resources.

In certain embodiments, a report may contain availability or non-availability of beams, panels, and/or spatial filters for a given time slot, duration, and so forth. Some beams and/or panels may be used for a UE to network interface (“Uu interface”) or transmission or reception with other SL UEs, and these beams and/or panels may be unavailable for transmission or reception from other TX UEs.

In some embodiments, a TX UE may transmit channel-specific reference signal (“CSR”) or interference reports (“IRs”) reports from a receiver UE based on consecutive negative acknowledgements (“NACKs”) and/or DTX.

In various embodiments, a number of consecutive NACKs and/or DTX used in different embodiments may be less than a maximum value (e.g., maxNumConsecutiveDTX) used for SL radio link failure (“RLF”).

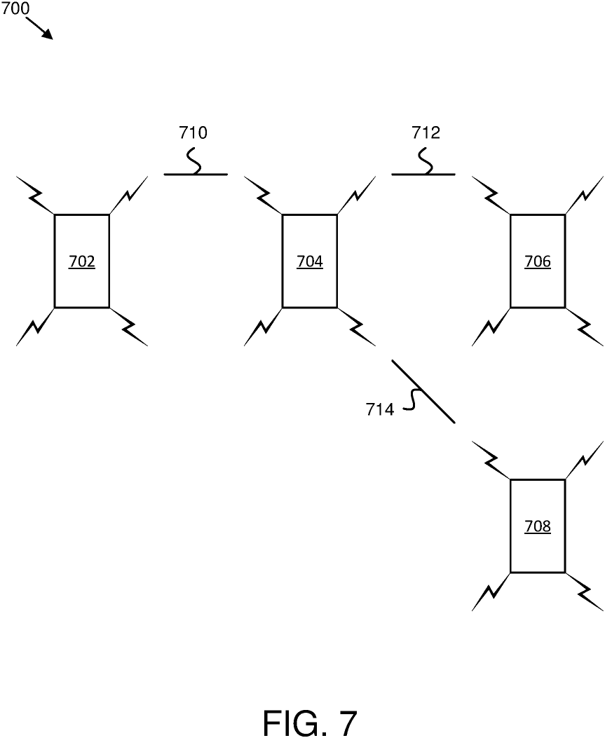

FIG. 7 is a schematic block diagram 700 illustrating a further embodiment of communications between user equipments. The diagram 700 includes a first UE 702 (TX UE A), a second UE 704 (RX UE), a third UE 706 (TX UE B), and a fourth UE 708 (TX UE C). A first communication 710 transmitted from the RX UE 704 to the TX UE A 702 may include an interference report that indicates a resource A 712 and a resource B 714. The resource A 712 may be used for communication between the RX UE 704 and the TX UE B 706. Moreover, the resource B 714 may be used for communication between the RX UE 704 and the TX UE C 708.

In certain embodiments, a TX UE considers Rx_IR in a candidate resource selection and exclusion process if the TX UE initiates a resource selection (or reslection) trigger for transmission to a destination. A corresponding report may include a corresponding source ID and/or destination ID.

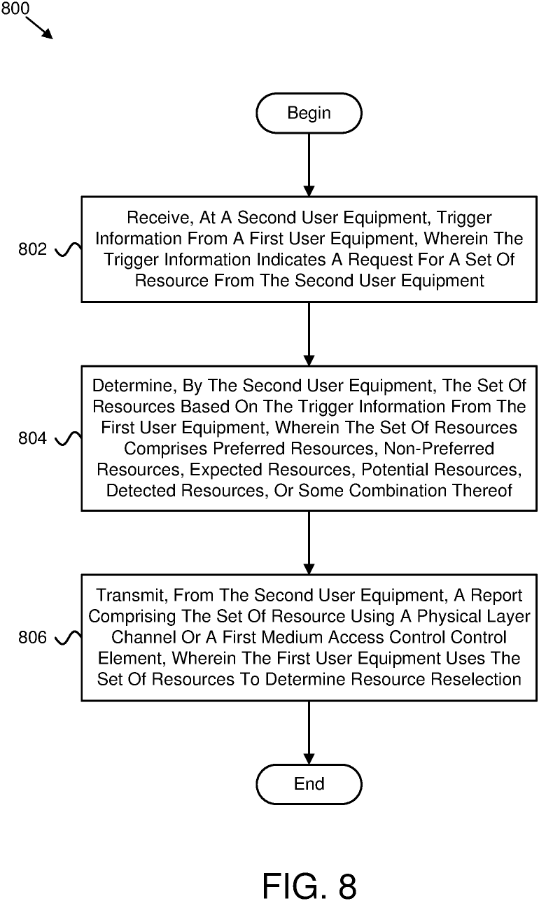

FIG. 8 is a flow chart diagram illustrating one embodiment of a method 800 for triggering a report of a set of resources. In some embodiments, the method 800 is performed by an apparatus, such as the remote unit 102. In certain embodiments, the method 800 may be performed by a processor executing program code, for example, a microcontroller, a microprocessor, a CPU, a GPU, an auxiliary processing unit, a FPGA, or the like.

In various embodiments, the method 800 includes receiving 802, at a second user equipment, trigger information from a first user equipment. The trigger information indicates a request for a set of resource from the second user equipment. In some embodiments, the method 800 includes determining 804, by the second user equipment, the set of resources based on the trigger information from the first user equipment. The set of resources includes preferred resources, non-preferred resources, expected resources, potential resources, and/or detected resources. In certain embodiments, the method 800 includes transmitting 806, from the second user equipment, a report including the set of resource using a physical layer channel or a first medium access control control element. The first user equipment uses the set of resources to determine resource reselection.

In certain embodiments, the trigger information is received using sidelink control information, a medium access control control element, radio resource control signaling, or some combination thereof. In some embodiments, the trigger information comprises a priority, a resource pool index, a subchannel size, a number of resources, a percentage of resources, a packet delay budget, or some combination thereof, and the trigger information facilitates the second user equipment performing sensing and candidate resource selection. In various embodiments, the request for the set of resources comprises a requested scheme for determining the set of resources, and the requested scheme for determining the set of resources indicates a preferred resource set, a non-preferred resource set, an expected resource conflict, a potential resource conflict, a detected resource conflict, or some combination thereof.

In one embodiment, the preferred resource set comprises resources on which a measured physical sidelink control channel reference signal received power or physical sidelink shared channel reference signal received power over demodulation reference signal resource elements during sensing and candidate resource selection is below a configured threshold. In certain embodiments, the non-preferred resource set comprises resources on which measured physical sidelink control channel reference signal received power or physical sidelink shared channel reference signal received power over demodulation reference signal resource elements during sensing and candidate resource selection is above a configured threshold. In some embodiments, the set of resources determined based on an expected resource conflict, a potential resource conflict, a detected resource conflict, or some combination thereof comprises resources reserved or transmitted by potential transmitters.

In various embodiments, the report is transmitted using a bitmap comprising a subchannel index in a resource pool. In one embodiment, the method 800 further comprises transmitting signaling comprising a preferred resource set, a non-preferred resource set, or a conflict resource set using a second medium access control control element. In certain embodiments, the method 800 further comprises receiving signaling in a second medium access control control element, wherein the signaling indicates a scheme for determining the set of resource set.

In some embodiments, the first medium access control control element comprises a predetermined priority, a predetermined latency, a predetermined scheduling, or some combination thereof. In various embodiments, the first medium access control control element is transmitted using a transport block multiplexed with user data. In one embodiment, the report is transmitted using a physical sidelink feedback channel, a physical sidelink shared channel, or sidelink control information.

In certain embodiments, the first user equipment determining resource reselection comprises determining resources to be used for a transmission resource based on: sensing result and coordination information; only on the coordination information; or partially on the coordination information. In some embodiments, the method 800 further comprises receiving an inter-user equipment coordination message based on the first user equipment receiving a predetermined number of consecutive negative acknowledgements.

In one embodiment, a method comprises: receiving, at a second user equipment, trigger information from a first user equipment, wherein the trigger information indicates a request for a set of resource from the second user equipment; determining, by the second user equipment, the set of resources based on the trigger information from the first user equipment, wherein the set of resources comprises preferred resources, non-preferred resources, expected resources, potential resources, detected resources, or some combination thereof; and transmitting, from the second user equipment, a report comprising the set of resource using a physical layer channel or a first medium access control control element, wherein the first user equipment uses the set of resources to determine resource reselection.

In certain embodiments, the trigger information is received using sidelink control information, a medium access control control element, radio resource control signaling, or some combination thereof.

In some embodiments, the trigger information comprises a priority, a resource pool index, a subchannel size, a number of resources, a percentage of resources, a packet delay budget, or some combination thereof, and the trigger information facilitates the second user equipment performing sensing and candidate resource selection.

In various embodiments, the request for the set of resources comprises a requested scheme for determining the set of resources, and the requested scheme for determining the set of resources indicates a preferred resource set, a non-preferred resource set, an expected resource conflict, a potential resource conflict, a detected resource conflict, or some combination thereof.

In one embodiment, the preferred resource set comprises resources on which a measured physical sidelink control channel reference signal received power or physical sidelink shared channel reference signal received power over demodulation reference signal resource elements during sensing and candidate resource selection is below a configured threshold.

In certain embodiments, the non-preferred resource set comprises resources on which measured physical sidelink control channel reference signal received power or physical sidelink shared channel reference signal received power over demodulation reference signal resource elements during sensing and candidate resource selection is above a configured threshold.

In some embodiments, the set of resources determined based on an expected resource conflict, a potential resource conflict, a detected resource conflict, or some combination thereof comprises resources reserved or transmitted by potential transmitters.

In various embodiments, the report is transmitted using a bitmap comprising a subchannel index in a resource pool.

In one embodiment, the method further comprises transmitting signaling comprising a preferred resource set, a non-preferred resource set, or a conflict resource set using a second medium access control control element.

In certain embodiments, the method further comprises receiving signaling in a second medium access control control element, wherein the signaling indicates a scheme for determining the set of resource set.

In some embodiments, the first medium access control control element comprises a predetermined priority, a predetermined latency, a predetermined scheduling, or some combination thereof.

In various embodiments, the first medium access control control element is transmitted using a transport block multiplexed with user data.

In one embodiment, the report is transmitted using a physical sidelink feedback channel, a physical sidelink shared channel, or sidelink control information.

In certain embodiments, the first user equipment determining resource reselection comprises determining resources to be used for a transmission resource based on: sensing result and coordination information; only on the coordination information; or partially on the coordination information.

In some embodiments, the method further comprises receiving an inter-user equipment coordination message based on the first user equipment receiving a predetermined number of consecutive negative acknowledgements.

In one embodiment, an apparatus comprises a second user equipment. The apparatus further comprises: a receiver that receives trigger information from a first user equipment, wherein the trigger information indicates a request for a set of resource from the second user equipment; a processor that determines the set of resources based on the trigger information from the first user equipment, wherein the set of resources comprises preferred resources, non-preferred resources, expected resources, potential resources, detected resources, or some combination thereof; and a transmitter that transmits a report comprising the set of resource using a physical layer channel or a first medium access control control element, wherein the first user equipment uses the set of resources to determine resource reselection.

In certain embodiments, the trigger information is received using sidelink control information, a medium access control control element, radio resource control signaling, or some combination thereof.

In some embodiments, the trigger information comprises a priority, a resource pool index, a subchannel size, a number of resources, a percentage of resources, a packet delay budget, or some combination thereof, and the trigger information facilitates the second user equipment performing sensing and candidate resource selection.

In various embodiments, the request for the set of resources comprises a requested scheme for determining the set of resources, and the requested scheme for determining the set of resources indicates a preferred resource set, a non-preferred resource set, an expected resource conflict, a potential resource conflict, a detected resource conflict, or some combination thereof.

In one embodiment, the preferred resource set comprises resources on which a measured physical sidelink control channel reference signal received power or physical sidelink shared channel reference signal received power over demodulation reference signal resource elements during sensing and candidate resource selection is below a configured threshold.

In certain embodiments, the non-preferred resource set comprises resources on which measured physical sidelink control channel reference signal received power or physical sidelink shared channel reference signal received power over demodulation reference signal resource elements during sensing and candidate resource selection is above a configured threshold.

In some embodiments, the set of resources determined based on an expected resource conflict, a potential resource conflict, a detected resource conflict, or some combination thereof comprises resources reserved or transmitted by potential transmitters.

In various embodiments, the report is transmitted using a bitmap comprising a subchannel index in a resource pool.

In one embodiment, the transmitter transmits signaling comprising a preferred resource set, a non-preferred resource set, or a conflict resource set using a second medium access control control element.

In certain embodiments, the receiver receives signaling in a second medium access control control element, and the signaling indicates a scheme for determining the set of resource set.

In some embodiments, the first medium access control control element comprises a predetermined priority, a predetermined latency, a predetermined scheduling, or some combination thereof.

In various embodiments, the first medium access control control element is transmitted using a transport block multiplexed with user data.

In one embodiment, the report is transmitted using a physical sidelink feedback channel, a physical sidelink shared channel, or sidelink control information.

In certain embodiments, the first user equipment determining resource reselection comprises determining resources to be used for a transmission resource based on: sensing result and coordination information; only on the coordination information; or partially on the coordination information.

In some embodiments, the receiver receives an inter-user equipment coordination message based on the first user equipment receiving a predetermined number of consecutive negative acknowledgements.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method comprising:
receiving, at a second user equipment, trigger information from a first user equipment, wherein the trigger information indicates a request for a set of resource from the second user equipment;
determining, by the second user equipment, the set of resources based on the trigger information from the first user equipment, wherein the set of resources comprises preferred resources, non-preferred resources, expected resources, potential resources, detected resources, or some combination thereof; and
transmitting, from the second user equipment, a report comprising the set of resource using a physical layer channel or a first medium access control control element, wherein the first user equipment uses the set of resources to determine resource reselection.

2. The method of claim 1, wherein the trigger information is received using sidelink control information, a medium access control control element, radio resource control signaling, or some combination thereof.

3. The method of claim 1, wherein the trigger information comprises a priority, a resource pool index, a subchannel size, a number of resources, a percentage of resources, a packet delay budget, or some combination thereof, and the trigger information facilitates the second user equipment performing sensing and candidate resource selection.

4. The method of claim 1, wherein the request for the set of resources comprises a requested scheme for determining the set of resources, and the requested scheme for determining the set of resources indicates a preferred resource set, a non-preferred resource set, an expected resource conflict, a potential resource conflict, a detected resource conflict, or some combination thereof.

5. The method of claim 4, wherein the preferred resource set comprises resources on which a measured physical sidelink control channel reference signal received power or physical sidelink shared channel reference signal received power over demodulation reference signal resource elements during sensing and candidate resource selection is below a configured threshold.

6. The method of claim 4, wherein the non-preferred resource set comprises resources on which measured physical sidelink control channel reference signal received power or physical sidelink shared channel reference signal received power over demodulation reference signal resource elements during sensing and candidate resource selection is above a configured threshold.

7. The method of claim 4, wherein the set of resources determined based on an expected resource conflict, a potential resource conflict, a detected resource conflict, or some combination thereof comprises resources reserved or transmitted by potential transmitters.

8. The method of claim 1, wherein the report is transmitted using a bitmap comprising a subchannel index in a resource pool.

9. The method of claim 1, further comprising transmitting signaling comprising a preferred resource set, a non-preferred resource set, or a conflict resource set using a second medium access control control element.

10. The method of claim 1, further comprising receiving signaling in a second medium access control control element, wherein the signaling indicates a scheme for determining the set of resource set.

11. The method of claim 1, wherein the first medium access control control element comprises a predetermined priority, a predetermined latency, a predetermined scheduling, or some combination thereof.

12. The method of claim 1, wherein the first medium access control control element is transmitted using a transport block multiplexed with user data.

13. The method of claim 1, wherein the report is transmitted using a physical sidelink feedback channel, a physical sidelink shared channel, or sidelink control information.

14. The method of claim 1, wherein the first user equipment determining resource reselection comprises determining resources to be used for a transmission resource based on:
sensing result and coordination information;
only on the coordination information; or
partially on the coordination information.

15. The method of claim 1, further comprising receiving an inter-user equipment coordination message based on the first user equipment receiving a predetermined number of consecutive negative acknowledgements.

16. An apparatus comprising a second user equipment, the apparatus further comprising:
a receiver that receives trigger information from a first user equipment, wherein the trigger information indicates a request for a set of resource from the second user equipment;
a processor that determines the set of resources based on the trigger information from the first user equipment, wherein the set of resources comprises preferred resources, non-preferred resources, expected resources, potential resources, detected resources, or some combination thereof; and
a transmitter that transmits a report comprising the set of resource using a physical layer channel or a first medium access control control element, wherein the first user equipment uses the set of resources to determine resource reselection.

17. The apparatus of claim 16, wherein the trigger information comprises a priority, a resource pool index, a subchannel size, a number of resources, a percentage of resources, a packet delay budget, or some combination thereof, and the trigger information facilitates the second user equipment performing sensing and candidate resource selection.

18. The apparatus of claim 16, wherein the request for the set of resources comprises a requested scheme for determining the set of resources, and the requested scheme for determining the set of resources indicates a preferred resource set, a non-preferred resource set, an expected resource conflict, a potential resource conflict, a detected resource conflict, or some combination thereof.

19. The apparatus of claim 18, wherein the preferred resource set comprises resources on which a measured physical sidelink control channel reference signal received power or physical sidelink shared channel reference signal received power over demodulation reference signal resource elements during sensing and candidate resource selection is below a configured threshold.

20. The apparatus of claim 18, wherein the non-preferred resource set comprises resources on which measured physical sidelink control channel reference signal received power or physical sidelink shared channel reference signal received power over demodulation reference signal resource elements during sensing and candidate resource selection is above a configured threshold.
